(19) United States
(12) Patent Application Publication
(10) Pub. No.: US 2008/0217110 A1
(43) Pub. Date: Sep. 11, 2008

(54) FLOOR CONVEYOR

(75) Inventor: Thomas Stolten, Tremsbuttel (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Jungheinrich Aktiengesellschaft, Hamburg (DE)

(21) Appl. No.: 12/041,134

(22) Filed: Mar. 3, 2008

(30) Foreign Application Priority Data
Mar. 6, 2007 (DE) 10 2007 010 697.3

(51) Int. Cl. B66F 9/22

(52) U.S. Cl. 187/234

(57) ABSTRACT

A floor conveyor with a drive portion and a load portion, wherein the load portion has a lifting scaffold, on which a carrier for a load fork or an attachment device is guided to be adjustable in height, and at least one hydraulic adjusting cylinder is assigned to the carrier for adjusting the load fork or a part on the attachment device, and wherein a hydraulic pump driven by a motor is arranged in the drive portion, which is connected to the adjusting cylinder via a proportional valve and hydraulic tubes, wherein the proportional valve is mounted on the carrier and an on-off valve is arranged on the drive portion, which connects the hydraulic tubes with the proportional valve or disconnects them from the same at option.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The invention is related to a floor conveyor which has, besides to a lifting and lowering function for a load pickup means, also secondary functions, for the load pickup means in particular.

Such a floor conveyor has become known from DE 698 07 098 T4 2004.07.15, the entire contents of which is incorporated herein by reference. Besides to the lifting and lowering function, moving the load fork away from the lifting mast and towards the same, respectively, and further also pivoting the load pickup means has to be accomplished. It is also known to tilt the load pickup means, the load fork for instance, not only around a horizontal axis, but also to shift it laterally along a horizontal axis. Finally, a so-called three-side stacker has also become known, in which the load fork can be pivoted around a vertical axis in addition.

In the floor conveyors, the actuation of the individual functions is usually performed in a hydraulic way. In the drive portion of the floor conveyor, a motor-driven hydraulic pump is arranged, which is connected with the control valves for the individual functions via tubes.

The functions of inclining and lateral trust of a load pickup means as well as those of optional attachment devices, which are attached on a height adjustable carrier, are usually actuated via proportional valves. Between the proportional valve, which is mostly arranged in the drive portion, and the consumer element on the lifting scaffold, there are often several meters of hydraulic tube. When a function is asked for, the hydraulic tube is pressurised. It is expanded in this act. Since the secondary functions require only a small volume flow, 6 to 8 millilitres per second for instance, a significant response delay of the secondary functions results from the effect mentioned above. This effect takes place more strongly with longer tubes, i.e. greater lifting heights, and with greater useful loads, because the storage capacity of the tubes increases together with the length of the tubes and with increasing pressure.

The present invention is based on the objective to provide a floor conveyor with secondary functions which can be actuated on the lifting scaffold, wherein the response delay of the secondary functions is reduced.

### BRIEF SUMMARY OF THE INVENTION

In the invention, the proportional valve is mounted on tie carrier and an on-off valve is arranged on the drive portion, which connects the hydraulic tube with the proportional valve or disconnects it from the same at option.

When the proportional valve is positioned immediately on the carrier, that one for the load fork for instance, near to the load, the tubes can be filled with a significantly higher volume flow than is necessary for the supply of the functions, because the throttling position is now no more upstream but downstream (on the load side) of the hydraulic tubes. Through this, the response time of the functions is decreased, since the dead time caused by the expansion of the tubes is reduced due to the rotational speed of the pump which must now be set to be greater. After the filling phase of the hydraulic tube, the rotational speed of the pump can provide for the necessary pressure reserve. The output pressure of the hydraulic pump is present immediately at the proportional valve. Through this, it is made sure that sufficient reserves are always present for the volume flow demand of the consumer element, which leads to a significantly more constant function speed, in particular when additional consumer elements are to be provisioned by the pump.

In order to shorten the dead time up to complete fullness of the tubes still further, the rotational speed of the pump may be significantly increased for a short time after a secondary function has been requested.

In particular, the present invention is suited for a function of laterally shifting the load fork and an inclination adjustment of the load fork around a horizontal axis. For each function, one adjusting cylinder is required at a time. According to one embodiment of the represent invention, these can be triggered via one common proportional valve, which has one neutral position as well as two working positions, wherein one hydraulic cylinder is assigned to each working position at a time.

It is usual to provide a pressure balance when triggering via a proportional valve, in order to control the preset volume flow. Therefore, the present invention provides that a pressure balance assigned to the proportional valve is also arranged on the carrier.

Summing it all up, it can therefore be stated that by the arrangement of the valves at the downstream or load side, respectively, of the tubes according to the present invention, the dynamic pressure before the proportional valve is not generated at the input side, but at the output side, i.e., at the load side of the hydraulic tubes, and thus it can be made higher. Volume flow and pressure become uniform through this, and the pressure drop in the lines is compensated.

### BRIEF DESCRIPTION OF THE SEVERAL VIEWS OF THE DRAWINGS

In the following, the present invention is explained in more detail by means of drawings.

FIG. 1 shows the side view of a reach mast truck, in a very schematic representation.

FIG. 2 shows a hydraulic circuitry arrangement for the reach mast truck according to FIG. 1.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

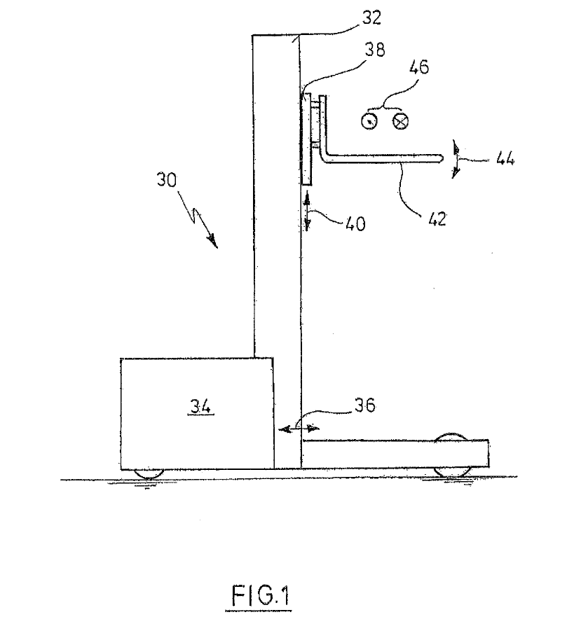

A reach mast truck 30 depicted in FIG. 1 has a lifting scaffold 32, which is held on the drive portion 34 and which is shiftable along the double arrow 36 with the aid of a not shown hydraulic cylinder. On the lifting scaffold 32, a carrier 38 is adjustable in the height, as is indicated by double arrow 40. On the carrier 38, a load fork 42 is attached, which is pivotable around a horizontal axis with the aid of an also not shown adjusting cylinder, as indicated by double arrow 44. In addition, the load fork 42 is shiftable with respect to the carrier 38 along a horizontal axis, as indicated by arrow ends 46. Even for this, an adjusting cylinder is necessary.

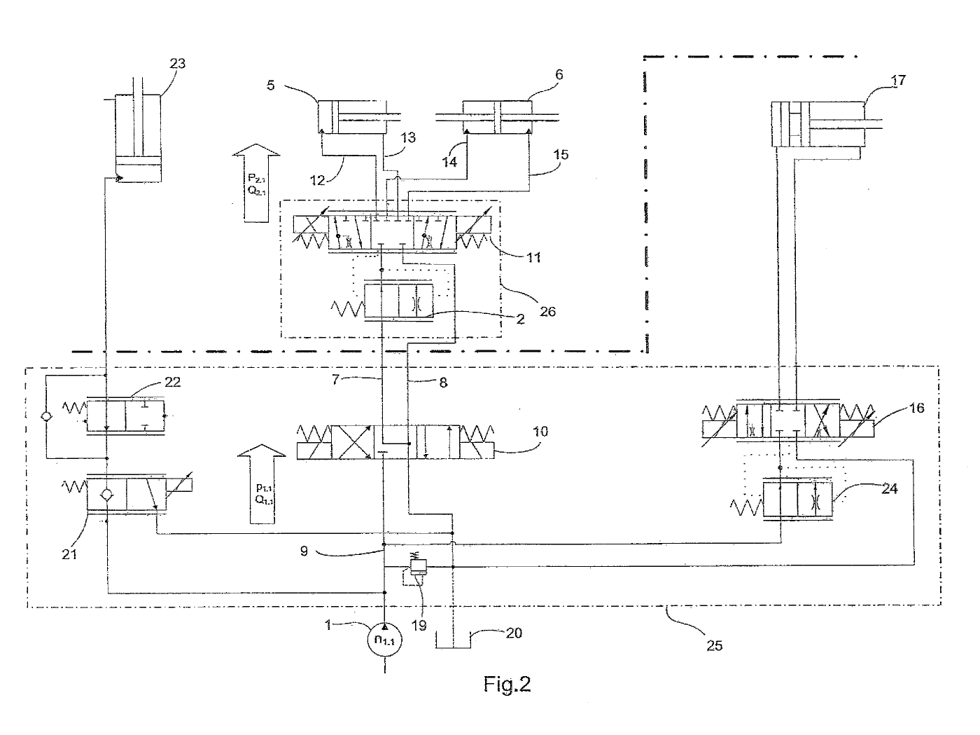

In FIG. 2, a lifting cylinder 23 for the lifting scaffold 32 can be recognised, which is connectable to a hydraulic pump 1 via a load holding and lowering valve 21 and a pressure balance 32.

Further, an adjusting cylinder 5 is provided in FIG. 2, for the inclination of the load fork 42, for instance. An adjusting cylinder 6 is provided for the lateral trust of the load fork 42 according to 46 in FIG. 1. An adjusting cylinder 17 is provided for the mast thrust 36.

The hydraulic adjusting cylinders 5, 6 and 17 are also provisioned by the hydraulic pump 1, which is driven by a not shown electric motor. It aspirates hydraulic medium from a tank 20. A pressure line 9 from the pump 1 leads to an on-off valve 10, which shuts up the pressure line 9 in the depicted neutral position. When there is a pressure burden, a pressure relief valve 19 reacts in order to lead medium back into the tank 20. From the on-off valve 10 depart two pressure lines 7, 8, which are guided to the adjusting cylinders 5, 6 in the form of hydraulic tubes. They may have a length of several meters, depending on the maximum lifting height of the load fork 42. At the end of the hydraulic lines 7, 8, a pressure balance 2 as well as a proportional valve 11 is arranged. These two hydraulic components are situated on the carrier 38 according to FIG. 1. The proportional valve 11 has a neutral position, in which both hydraulic cylinders 5, 6 are not supplied with medium. In the one working position, a supply of one of the two hydraulic cylinders 5, 6 takes place in proportion to the triggered electric magnet for the proportional valve. In this, the pressure balance 2 provides that a controlled volume flow is supplied to the hydraulic cylinder 5 or 6, respectively. It depends on the operating position of the on-off valve 10 which side of the hydraulic valve 5 or 6, respectively, is supplied with pressure means and which side is connected to the tank 10.

The hydraulic unit (valve block) constituted by pressure balance 2 and proportional valve 11, enclosed by the dash-dot line 26, is located on the carrier 38 for the load fork 42.

A proportional valve 16, to which a pressure balance 24 is upstream connected, is also housed in the vehicle, namely in the drive portion 34, and it provides for the proportional triggering of the working cylinder 17 for the mast thrust.

The valve block according to FIG. 2 is located on the vehicle.

During the filling phase of the hydraulic lines (tubes) 7, 8 we have Q_{1.1}>Q₁. Q is the volume flow at the pump rotational speed n. Q_{1.1} is the volume flow at the pump rotational speed n₁. During the movement phase, Q_{1.1} is greater than or equal to Q₁. After the filling phase of the tube, the rotational speed n₁ of the pump 1 provides for the necessary pressure reserve p_{1.1}. The pressure p_{1.1} between pump 1 and pressure balance 2 is greater than p_{2.1}, i.e. on the input of the cylinders 5, 6. Through this it is made sure that sufficient reserves are anytime at hand for the volume flow request of the hydraulic cylinders 5, 6, which results in a constant function speed.

In order to further reduce the dead time until the hydraulic tubes 7, 8 are completely filled, the pump rotational speed can be significantly enforced for a short time upon request of a function. Through this, volume flow Q_{2.1} between proportional valve 11 and cylinder 5 or 6 and the pressure p_{2.1} becomes more uniform, and the pressure in the lines 7, 8 is compensated.

Generally, the following relations apply:

Q₁>Q₂

Q₁<Q_{1.1}

Q₂≦Q_{2.1}

Q₂≦Q_{1.1}

Q_{1.1}>Q_{2.1}

p₁>p₂

p_{1.1}>p_{2.1}

p₁<p_{1.1}

p₂≦p_{2.1}

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g, each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below. This completes the description of the preferred and alternate embodiments of the invention. Those skilled in the art may recognize other equivalents to the specific embodiment described herein which equivalents are intended to be encompassed by the claims attached hereto.

What is claimed is:

1. A floor conveyor with a drive portion and a load portion, wherein the load portion has a lifting scaffold, on which a carrier for a load fork or an attachment device is guided to be adjustable in height, and at least one hydraulic adjusting cylinder is assigned to the carrier for adjusting the load fork or a part on the attachment device, and wherein a hydraulic pump driven by a motor is arranged in the drive portion, which is connected to the adjusting cylinder via a proportional valve and hydraulic tubes, characterised in that the proportional valve (11) is mounted on the carrier (38) and an on-off valve (10) is arranged on the drive portion (34), which connects the hydraulic tubes (7, 8) with the proportional valve (1) or disconnects them from the same at option.

2. A floor conveyor according to claim 1, characterised in that the load fork (42) is laterally shiftable and/or is hinged mounted in its inclination towards the horizontal, and an adjusting cylinder is provided for shifting and/or for inclining.

3. A floor conveyor according to claim 2, characterised in that the two adjusting cylinders (5, 6) are connected with the hydraulic tubes (7, 8) via a proportional valve (11), which has one neutral position and two working positions, wherein one working position is assigned to one adjusting cylinder at a time (5, 6).

4. A floor conveyor according to claim 1, characterised in that a pressure balance (2) connected upstream to the proportional valve (11) is also arranged on the carrier (38).

5. A floor conveyor according to claim 1, characterised in that a control device is provided, which upon actuation of an adjusting cylinder (5, 6) triggers the pump motor (1) such that it has an excessive rotational speed for a short time.
